(19) United States
(12) Patent Application Publication
(10) Pub. No.: US 2002/0171630 A1
(43) Pub. Date: Nov. 21, 2002

(54) Hand-held device for cleaning the deposits on the internal rollers of a computer mouse

(76) Inventor: Terrence L.W. Peacemaker, Fredericksburg, VA (US)

Correspondence Address: Law Office - Dinesh Agarwal, P.C., Suite 330, 5350 Shawnee Road, Alexandria, VA, 22312, US

(21) Appl. No.: 09/859,594

(22) Filed: May 18, 2001

(51) Int. Cl. G09G 5/08; G09G 5/00

(52) U.S. Cl. 345/163

(57) ABSTRACT

A hand-held device for cleaning the deposits on the internal rollers of a computer mouse, includes a generally elongated handle with first and second end portions. An abrasive cleaning member is positioned at one of the first and second end portions, and a scraping member is positioned at the other of the first and second end portions. The scraping member includes a generally pointed apex portion. The handle is shaped to be held by a plurality of fingers of a user for manually cleaning the internal rollers of a computer mouse.

### FIELD AND HISTORICAL BACKGROUND OF THE INVENTION

The present invention is directed to computer mouse accessories, and more particularly to a hand-held device for cleaning the deposits on the internal rollers of a computer mouse.

In the last decade, the presence of input devices for personal computers, such as pointer devices for cursor control, for example, mouse or track ball devices, has became ubiquitous. These devices are used for controlling the movement of a cursor on a computer screen. More specifically, a computer mouse is a device that a computer user typically uses on a suitable pad to thereby control the movement of the cursor and cursor-related functions on a computer screen. A computer mouse includes a calibrated ball in a recess on the underside thereof that rolls across the surface of the pad as the mouse is moved thereon. The ball is in engagement with a plurality of rollers that rotate as the ball rotates when the mouse is moved across the pad. The movement of the rollers is then translated into electric instructions that are transmitted to the computer to cause the cursor on the associated connected computer screen to move in response to the movement of the mouse ball on the pad.

A track ball operates in the same manner as a conventional mouse except that instead of moving the input device across a mouse pad, the device itself remains stationary and the user manipulates the ball directly to control the movement of the cursor on the computer screen.

Since the surface of the ball is exposed to the surrounding environment, the ball becomes contaminated with dust, lint, grime, hair and other particulate matter typically present therearound. Since the ball is in engagement with the rollers, the contaminants get transferred onto the roller surfaces and, as a result, the roller and other associated internal parts also become contaminated. This contamination tends to adversely affect proper functioning of the mouse which results in improper or undesired instructions to the computer. In order to rid the contaminants, the mouse cover must be removed and the ball and the rollers cleaned.

Presently, there is no effective or easy way to clean the contaminated components of a computer mouse. Although a few mouse cleaning devices are available, they are not fully satisfactory in properly cleaning a contaminated mouse.

Examples of mouse and other cleaning devices are disclosed in U.S. Pat. Nos. 6,196,898 B1; 6,081,956; 5,996,165; 5,438,726; 4,205,664; and 3,783,467.

### OBJECTS AND SUMMARY OF THE INVENTION

The principal object of the present invention is to provide a hand-held device for cleaning the deposits on the internal rollers of a computer mouse which overcomes the drawbacks associated with conventional devices.

An object of the present invention is to provide a hand-held device for cleaning the deposits on the internal rollers of a computer mouse which is simple in structure and easy to use.

Another object of the present invention is to provide a handheld device for cleaning the deposits on the internal rollers of a computer mouse which is simple in design and inexpensive to manufacture.

An additional object of the present invention is to provide a hand-held device for cleaning the deposits on the internal rollers of a computer mouse which allows a user to apply a direct and positive amount of necessary force to effectively clean the stubborn deposits on the internal rollers of the mouse.

Yet an additional object of the present invention is to provide a hand-held device for cleaning the deposits on the internal rollers of a computer mouse which includes generally pointed end portions that allow a user to surgically and precisely remove various deposits, and particularly hard deposits, on the internal rollers of the computer mouse.

In summary, the main object of the present invention is to provide a hand-held device for cleaning the deposits on the internal rollers of a computer mouse which allows a user to effectively rid of deposits on the internal rollers of a mouse by applying a direct, positive, focused and controlled force. The device is simple in design and inexpensive to manufacture.

In accordance with the present invention, a hand-held device for cleaning the deposits on the internal rollers of a computer mouse, includes a generally elongated handle with first and second end portions. An abrasive cleaning member is positioned at one of the first and second end portions, and a scraping member is positioned at the other of the first and second end portions. The scraping member includes a generally pointed apex portion. The handle is shaped to be held by a plurality of fingers of a user for manually cleaning the internal rollers of a computer mouse.

### BRIEF DESCRIPTION OF THE DRAWINGS

The above and other objects, novel features and advantages of the present invention will become apparent from the following detailed description of the invention, as illustrated in the drawings, in which:

FIG. 1 is an elevational view of a computer mouse cleaning device in accordance with the present invention;

FIG. 2 is a side elevational view of the device shown in FIG. 1;

FIG. 3 is a view similar to FIG. 1, showing a first alternative embodiment of the computer mouse cleaning device of the present invention;

FIG. 4 is a side elevational view of the device shown in FIG. 3;

FIG. 5 is a view similar to FIG. 1, showing a second alternative embodiment of the computer mouse cleaning device of the present invention;

FIG. 6 is an enlarged, partial, vertical sectional view of the device shown in FIG. 5;

FIG. 7 is an enlarged sectional view taken along line 7-7 of FIG. 5;

FIG. 8 is a sectional view taken along line 8-8 of FIG. 1;

FIG. 9 is a view similar to FIG. 1, showing a third alternative embodiment of the computer mouse cleaning device of the present invention;

FIG. 10 is a sectional view taken along line 10-10 of FIG. 9;

FIGS. 11-14 are enlarged views of the abrasive cleaning member showing various patterns for the ridges thereon;

FIG. 15 is an enlarged sectional view taken along line 15-15 of FIG. 11; and

FIG. 16 shows the computer mouse cleaning device of FIG. 1 in use.

### DETAILED DESCRIPTION OF THE INVENTION

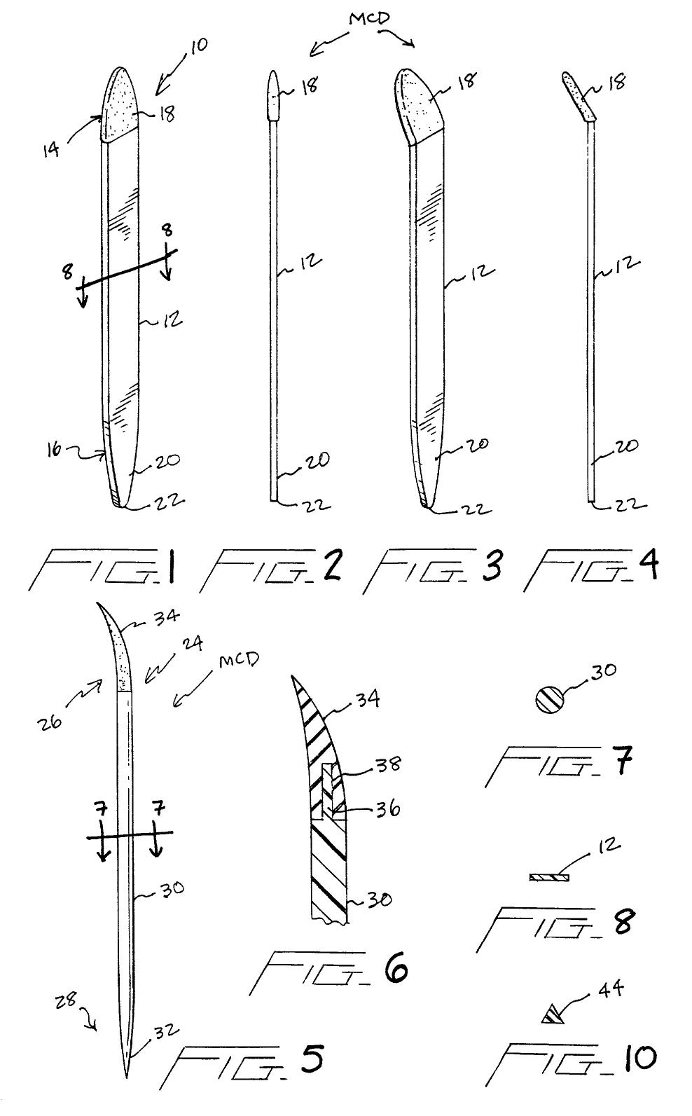

As best shown in FIG. 1, the computer mouse cleaning device MCD of the invention is in the form of an elongated member 10 made of a plastic, metal, or other suitable generally rigid material. As shown in FIG. 8, the member 10 is generally rectangularly-shaped and provides a middle handle portion 12, and top and bottom portions 14 and 16, respectively. The top portion 14 preferably includes an abrasive cleaning member 18, and the bottom portion 16 includes an angularly-shaped scraping member 20. The scraping member 20 is preferably integral with the handle portion 12 and includes a somewhat rounded, pointed apex portion 22. The abrasive member 18 may also be integral with the handle portion 12 by having provided thereon conventional abrasive particles or ridges, as described below. Alternatively, a separate abrasive member having the general configuration of the top portion 14 may be formed which would then be slipped over the top portion 14. As shown in FIGS. 1-2, the elongated member 10 preferably has a substantially uniform thickness throughout the length thereof.

FIGS. 3-4 illustrate a first alternative embodiment, which is similar to the embodiment shown in FIGS. 1-2 and 8, with the exception that the top portion 14 is inclined at an angle to the handle portion 12. Preferably, the top portion 14 forms an angle of about 30°-60° relative to the handle portion 12.

FIGS. 5-7 illustrate a second alternative embodiment of the computer mouse cleaning device MCD of the present invention, which includes a generally round elongated member 24 including top and bottom portions 26 and 28, respectively, and a middle handle portion 30. As shown in FIG. 5, the bottom portion 28 is preferably integral with the handle 30, and includes a pointed scraping portion 32. The top portion 26 includes a generally curved member 34, made of a resilient yet flexible material, such as rubber, forming a curved, pointed abrasive cleaning member 34. As best shown in FIG. 6, the abrasive cleaning member 34 is removably mounted on the handle 30 by a tongue and groove arrangement. In particular, the handle 30 includes a projection 36 which is received in a corresponding recess 38 in the cleaning member 34. The external dimensions of the projection 36 are selected to be slightly greater than the internal dimensions of the recess 38 to thereby provide a secure and snug fit therebetween. Although not shown, prior to mounting the cleaning member 34 on the handle 30, a suitable adhesive may be applied on the projection 36 to thereby produce a durable bond between the projection 36 and the recess 38. Preferably, the handle 30 and the bottom portion 28 are made of wood, plastic, or a suitable generally rigid material.

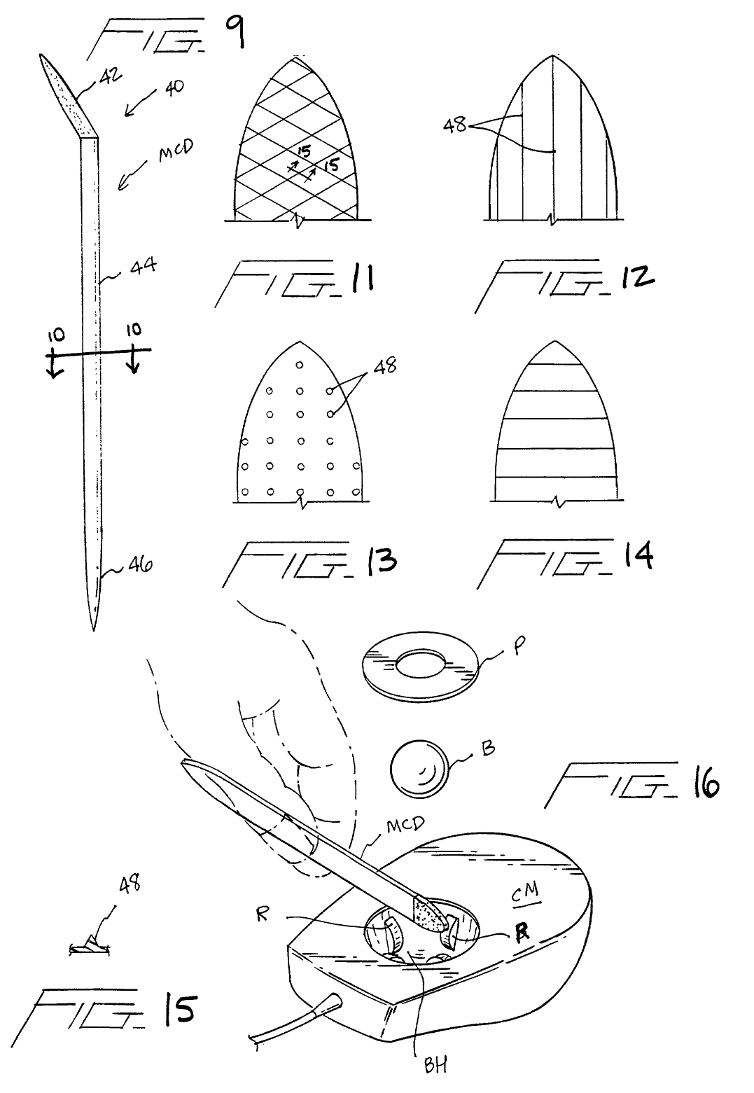

FIG. 9 illustrates a third alternative embodiment of the computer mouse cleaning device MCD of the present invention, which is similar to the embodiment shown in FIGS. 5-7, with the exception that its elongated member 40 is generally triangular in cross-section, and the top abrasive cleaning member 42 is rectilinear in configuration but mounted at an angle of about 30°-60° relative to the handle portion 44. As in the previous embodiment, the bottom pointed portion 46 is preferably integral with the handle portion 44, and is made of a wood, plastic, or a suitable generally rigid material.

FIGS. 11-14 illustrate the formation of the abrasive cleaning member for the illustrated embodiments. In particular, the abrasive cleaning members, such as 18, 34 and 42, may include abrasive projections 48 that may be arranged in different patterns. For example, abrasive projections that are generally triangular in cross-section (FIG. 15), may be randomly distributed throughout the surface area of the cleaning member. Alternatively, the abrasive projections 48 may be arranged along lines that criss-cross to form a diamond-like pattern (FIG. 11), run vertically (FIG. 12) or horizontally (FIG. 14), or criss-cross in vertical and horizontal directions (FIG. 13). Although it is preferable that abrasive projections be triangular in cross-section (FIG. 15), other shapes and configurations may be used. Likewise, patterns other than illustrated in FIGS. 11-14, may also be used. For example, the projections 48 may be arranged along curved or wave-like lines.

As illustrated in FIG. 16, in order to clean a computer mouse CM, a user would first remove the ball B by removing the associated cover plate P. Once the ball B has been removed, the mouse cleaning device MCD of the present invention can be easily used to cause the precise removal of contaminants from the rollers R provided in the ball housing BH. In particular, by placing either the abrasive cleaning member or the pointed scraping member directly adjacent stubborn or hard-deposits, the user may easily remove or scrap-off the contaminants by applying a direct force thereon.

While this invention has been described as having preferred ranges, steps, materials, or designs, it is understood that it is capable of further modifications, uses and/or adaptations of the invention following in general the principle of the invention, and including such departures from the present disclosure, as those come within the known or customary practice in the art to which the invention pertains and as may be applied to the central features hereinbefore set forth, and fall within the scope of the invention and of the appended claims. It is further understood that the present invention is not limited to the claims appended hereto.

What is claimed is:

1. A hand-held device for cleaning the deposits on the internal rollers of a computer mouse, comprising:
a) a generally elongated handle including first and second end portions;
b) an abrasive cleaning member positioned at one of said first and second end portions;
c) a scraping member positioned at the other of said first and second end portions;
d) said scraping member including a generally pointed apex portion; and
e) said handle being shaped to be held by a plurality of fingers of a user for manually cleaning the internal rollers of a computer mouse.

2. The device of claim 1, wherein:
a) said abrasive cleaning member is inclined at an angle relative to said elongated handle.

3. The device of claim 2, wherein:
a) said angle is about 30°-60°.

4. The device of claim 3, wherein:
a) said elongated handle is substantially rectangular, triangular, or round in cross-section.

5. The device of claim 4, wherein:
a) said elongated handle and said first and second end portions have a substantially uniform thickness.

6. The device of claim 1, wherein:
a) said abrasive cleaning member includes a cleaning surface; and
b) said cleaning surface includes a plurality of ridges arranged in a pattern.

7. The device of claim 6, wherein:
a) said pattern comprises a plurality of vertical, horizontal, or diagonally extending parallel lines.

8. The device of claim 7, wherein:
a) a plurality of said ridges are generally triangular in cross-section.

9. The device of claim 1, wherein:
a) said abrasive cleaning member is curved.

10. The device of claim 9, wherein:
a) said abrasive cleaning member is made of a rubber material and is removably mounted on said elongated handle.

11. The device of claim 10, wherein:
a) said handle is made of a rigid material.

12. The device of claim 10, wherein:
a) one of said abrasive cleaning member and said handle comprises a projection; and
b) the other of said abrasive cleaning member and said handle comprises a recess for receiving said projection.

13. The device of claim 1, wherein:
a) said elongated handle and said first and second end portions extend in substantially the same plane.

14. The device of claim 1, wherein:
a) said scraping member is made of the same material as said elongated handle and is integral therewith.

15. The device of claim 1, wherein:
a) said abrasive cleaning member comprises a generally flat member including laterally spaced curved edges; and
b) said curved edges converge in one direction to form a generally rounded apex.

16. The device of claim 15, wherein:
a) said curved edges diverge in a second direction generally opposite to said first direction to a width that generally corresponds to the width of said elongated handle.

17. The device of claim 1, in combination with a computer mouse.
